(19) United States
(12) Patent Application Publication
(10) Pub. No.: US 2026/0307256 A1
(43) Pub. Date: Oct. 8, 2026

(54) METHOD FOR SETTING VIRTUAL BOUNDARY OF WORK AREA OFCOLLABORATIVE ROBOT BASED ON USER INTERFACE, AND COMPUTER PROGRAM RECORDED ON RECORD-MEDIUM FOR EXECUTING METHOD THEREFOR

(71) Applicant: BRILS Co., Ltd., Incheon (KR)

(72) Inventor: Jin JEON, Incheon (KR)

(21) Appl. No.: 19/638,221

(22) Filed: Apr. 3, 2026

(30) Foreign Application Priority Data
Apr. 4, 2025 (KR) 10-2025-0044382

(51) Int. Cl. B25J 9/16

(52) U.S. Cl. CPC B25J 9/1676; B25J 9/1666; B25J 9/1671; B25J 9/1682

(57) ABSTRACT

A user interface-based method for setting a virtual boundary of a work area of a collaborative robot, and a computer program recorded on record-medium for executing method therefor, are described. A management server may set a work plan of a collaborative robot, estimate a work path of the collaborative robot according to the set work plan, and set a virtual safety fence based on the estimated work path of the collaborative robot. The work plan may be set based on at least one of operation speed information, kinematics information, and obstacle information of the collaborative robot, or may be input by an administrator through a GUI (Graphical User Interface) for moving a virtual collaborative robot corresponding to the collaborative robot.

### CROSS REFERENCE TO RELATED APPLICATION

The present application claims priority to Korean Patent Application No. 10-2025- 0044382, filed April 04, 2025, the entire contents of which are incorporated here for all purposes by this reference.

### TECHNICAL FIELD

The present disclosure relates to a Safety Management System for a collaborative robot. More particularly, the present disclosure relates to a user interface-based method for setting a virtual boundary of a work area of a collaborative robot, and a computer program recorded on record-medium for executing method therefor, for setting a virtual safety fence capable of securing safety according to a work plan of the collaborative robot.

### BACKGROUND

A logistics automation system refers to a system that automates packaging, sorting, loading, and transporting processes of articles for the purpose of improving logistics efficiency through convergence of Internet of Things (IoT) technology, robot technologies such as autonomous driving, and artificial intelligence technologies for environment recognition, situation recognition, and work planning through learning in logistics centers, factories, and the like.

Meanwhile, a collaborative robot is a robot having a concept of a partner that collaborates with a human in a space not separated from the human, and has recently attracted attention due to advantages of relatively low cost and rapid applicability in various industrial fields. In addition, the collaborative robot has advantages such as convenience of operation and ease of process rearrangement over a conventional industrial robot, and thus may be flexibly used for various processes and tasks. Recently, unlike an industrial robot that mainly performs simple repetitive tasks, the collaborative robot has served as a fusion system in which IT (Information & communication Technology) technologies such as artificial intelligence, human interface, and ubiquitous networks are integrated.

In order to implement collaborative work between a human and a robot using the collaborative robot, three characteristic factors, i.e., safety, coexistence, and collaboration, should be satisfied. In particular, safety refers to an ability to avoid a collision with a worker or a response capability by which the robot detects a collision and avoids a risk resulting from the collision in an unavoidable collision.

Recently, in order to secure safety in implementation of collaborative work between a collaborative robot and a human, regulations have required installation of a fence or a sensitive protective device in a work area, but such measures alone have made it difficult to secure worker safety.

In order to solve such a problem, a Virtual Boundary has drawn attention. The Virtual Boundary is a technology for preventing collisions by setting an invisible boundary in an actual space using a sensor mounted on a robot, a vision system, a position recognition device, and the like, and actively controlling an operation of the robot according to a position of a worker or whether the worker approaches the robot.

However, in order to effectively operate the Virtual Boundary, a user interface (UI, User Interface) is required through which a user can easily set a position, range, sensitivity, and the like of the boundary and adjust the same in real time. In general, a user interface for setting the Virtual Boundary has had problems in that it is difficult for a non-expert to use because boundary setting should be performed through coordinate value input or complex system setting, and it is difficult to flexibly respond to changes in a real-time work environment.

### RELATED ART DOCUMENT

(Patent Document 0001) Korean Patent Application Publication No. 10-2024-0094181, entitled “Logistics Automation Robot,” published on Jun. 25, 2024.

An object of the present disclosure is to provide a user interface-based method for setting a virtual boundary of a work area of a collaborative robot, for setting a virtual safety fence capable of securing safety according to a work plan of the collaborative robot.

Another object of the present disclosure is to provide a computer program recorded on record-medium for executing method therefor, for a user interface-based method for setting a virtual boundary of a work area of a collaborative robot, for setting a virtual safety fence capable of securing safety according to a work plan of the collaborative robot.

Technical problems of the present disclosure are not limited to those mentioned above, and other technical problems not mentioned herein will be clearly understood by those skilled in the art from the following description.

To achieve the above-described objects, the present disclosure proposes a user interface-based method for setting a virtual boundary of a work area of a collaborative robot, for setting a virtual safety fence capable of securing safety according to a work plan. The method may include setting, by a management server, a work plan of a collaborative robot, estimating, by the management server, a work path of the collaborative robot according to the set work plan, and setting, by the management server, a virtual safety fence based on the estimated work path of the collaborative robot.

Specifically, setting the work plan may be characterized by setting the work plan based on at least one of operation speed information, kinematics information, and obstacle information of the collaborative robot.

Specifically, setting the work plan may be characterized by generating a virtual collaborative robot corresponding to the collaborative robot, and receiving, from an administrator, the work plan through a GUI (Graphical User Interface) for moving the virtual collaborative robot.

The estimating may be characterized by simulating a movement of the collaborative robot based on the set work plan to generate a Route map in which a movement path of the collaborative robot is superimposed.

The estimating may be characterized by setting a view point to a top view, and simulating a movement of the collaborative robot to generate the Route map.

The setting may be characterized by setting a virtual safety fence corresponding to an actual movement path of the collaborative robot based on an edge of an area corresponding to the collaborative robot on the Route map.

The setting may be characterized by setting a pillar-shaped virtual safety fence having, as a bottom surface and a top surface thereof, the edge of the area corresponding to the collaborative robot on the Route map.

The estimating may be characterized by estimating a work radius based on coordinates of the collaborative robot according to the work plan and a shape of the collaborative robot.

The setting may be characterized by setting a virtual safety fence spaced apart by a preset distance or more from an edge of the estimated work radius.

The setting may be characterized by variably setting a size of the virtual safety fence according to a speed of the collaborative robot according to the work plan.

The setting may be characterized by variably setting a color of the virtual safety fence according to a speed of the collaborative robot according to the work plan.

The setting may be characterized by receiving proficiency of a worker to work together with the collaborative robot according to the work plan, and variably setting a size of the virtual safety fence according to the received proficiency of the worker.

To achieve the above-described objects, the present disclosure proposes a computer program recorded on record-medium for executing method therefor. The computer program may be coupled with a computing device comprising a memory, a transceiver, and a processor configured to process instructions resident in the memory. The computer program may be a computer program recorded on record-medium for causing the processor to execute setting a work plan of a collaborative robot, estimating a work path of the collaborative robot according to the set work plan, and setting a virtual safety fence based on the estimated work path of the collaborative robot.

Specific matters of other embodiments are included in the following detailed description and the accompanying drawings.

According to various embodiments of the present disclosure, a work plan of a collaborative robot may be set based on a user interface, and a work path may be automatically estimated based thereon to set a virtual safety fence, thereby reducing time required for setting the virtual safety fence and improving reliability through visual feedback.

Effects of the present disclosure are not limited to those mentioned above, and other effects not mentioned herein will be clearly understood by those skilled in the art from the scope of the claims.

### BRIEF DESCRIPTION OF THE DRAWINGS

FIG. 1 is a configuration diagram of a Safety Management System according to an embodiment of the present disclosure.

FIG. 2 is a logical configuration diagram of a management server according to an embodiment of the present disclosure.

FIG. 3 is an exemplary diagram illustrating a Route map according to an embodiment of the present disclosure.

FIG. 4 is an exemplary diagram illustrating a virtual safety fence according to an embodiment of the present disclosure.

FIG. 5 is an exemplary diagram for explaining a function of a detection unit according to an embodiment of the present disclosure.

FIGS. 6 and 7 are exemplary diagrams for explaining a GUI (Graphical User Interface) according to an embodiment of the present disclosure.

FIG. 8 is a hardware configuration diagram of a management server according to an embodiment of the present disclosure.

FIG. 9 is a flowchart for explaining a user interface-based method for setting a virtual boundary of a work area of a collaborative robot according to an embodiment of the present disclosure.

FIG. 10 is a flowchart for explaining a virtual boundary-based collision prevention and work control method using safety signal linkage of a collaborative robot according to an embodiment of the present disclosure.

FIG. 11 is a flowchart for explaining an intuitive control method of a collaborative robot using a user-centered graphic interface according to an embodiment of the present disclosure.

### DETAILED DESCRIPTION

It should be noted that technical terms used herein are used only for describing specific embodiments and are not intended to limit the present disclosure. In addition, unless technical terms used herein are specifically defined otherwise herein, the technical terms should be construed as having meanings generally understood by those skilled in the art to which the present disclosure pertains, and should not be construed as having overly broad meanings or overly narrow meanings. Further, when a technical term used herein is an erroneous technical term that does not accurately express the spirit of the present disclosure, it should be understood as being replaced by a technical term that can be correctly understood by those skilled in the art. In addition, general terms used in the present disclosure should be construed according to dictionary definitions or according to context, and should not be construed as having overly narrow meanings.

In addition, singular expressions used herein include plural expressions unless the context clearly indicates otherwise. In the present application, terms such as “configured” or “having” should not be construed as necessarily including all of various components or various steps described in the specification, and it should be construed that some of the components or some of the steps may not be included, or additional components or steps may further be included.

In addition, terms including ordinals such as first, second, and the like used herein may be used to describe various components, but the components should not be limited by the terms. The terms are used only for the purpose of distinguishing one component from another component. For example, without departing from the scope of the present disclosure, a first component may be named a second component, and similarly, a second component may also be named the first component.

When a component is referred to as being “connected” or “coupled” to another component, the component may be directly connected or coupled to the other component, but it should be understood that another component may be present therebetween. On the other hand, when a component is referred to as being “directly connected” or “directly coupled” to another component, it should be understood that no other component is present therebetween.

Hereinafter, preferred embodiments according to the present disclosure will be described in detail with reference to the accompanying drawings. The same or similar components will be denoted by the same reference numerals regardless of the reference numerals in the drawings, and duplicate descriptions thereof will be omitted. In addition, when it is determined that a detailed description of related known technology may unnecessarily obscure the subject matter of the present disclosure, the detailed description thereof will be omitted. It should also be noted that the accompanying drawings are only for easily understanding the spirit of the present disclosure, and the spirit of the present disclosure should not be construed as being limited by the accompanying drawings. The spirit of the present disclosure should be construed as extending to all modifications, equivalents, and substitutes in addition to the accompanying drawings.

Meanwhile, as described above, in order to implement collaborative work between a human and a robot using a collaborative robot, three characteristic factors, i.e., safety, coexistence, and collaboration, should be satisfied. In particular, safety refers to an ability to avoid a collision with a worker or a response capability by which the robot detects a collision and avoids a risk resulting from the collision in an unavoidable collision.

Recently, in order to secure safety in implementation of collaborative work between a collaborative robot and a human, regulations have required installation of a fence or a sensitive protective device in a work area, but such measures alone have made it difficult to secure worker safety.

In order to overcome such limitations, the present disclosure proposes various means capable of managing safety against collisions between a collaborative robot and a worker.

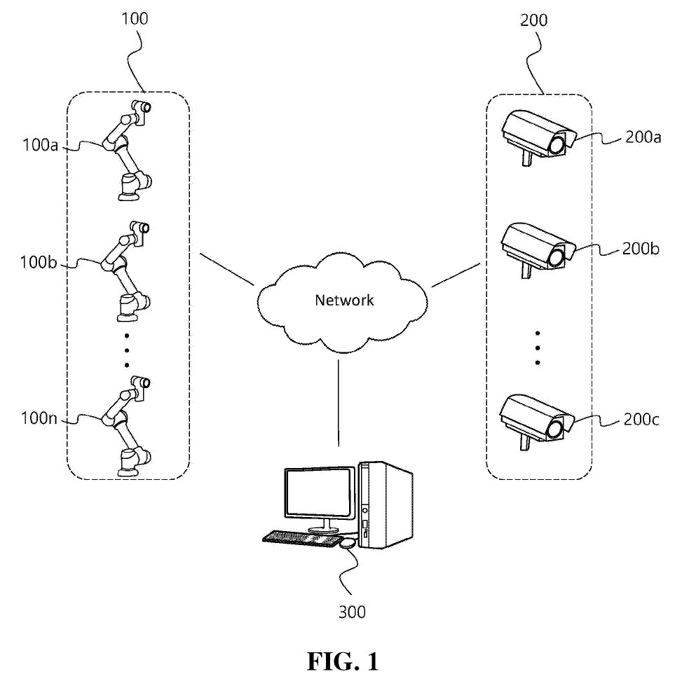

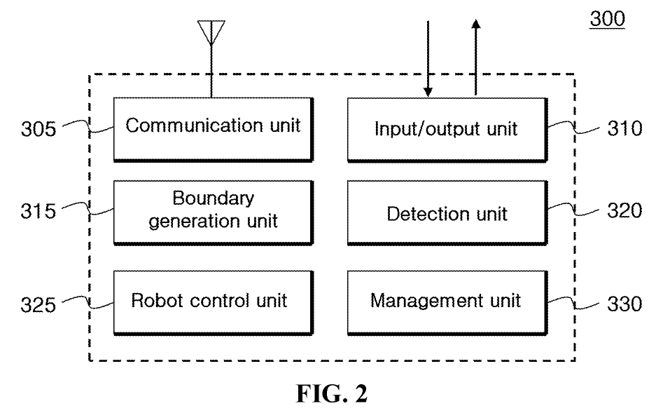

FIG. 1 is a configuration diagram of a Safety Management System according to an embodiment of the present disclosure. Referring to FIGS. 1 and 2, the Safety Management System according to an embodiment of the present disclosure may include at least one collaborative robot (100a, 100b, ..., 100n; 100), at least one camera (200a, 200b, ..., 200n; 200), and a management server (300).

Components of the Safety Management System according to an embodiment of the present disclosure merely represent functionally distinguished components, and thus two or more components may be implemented in an integrated manner in an actual physical environment, or one component may be implemented in a separated manner in an actual physical environment.

Describing each component, the collaborative robot 100 may be a device capable of performing transfer, loading, sorting, and the like of articles in cooperation with a worker in an industrial field.

For example, the collaborative robot 100 may be a device for gripping an article and moving a position thereof. In the following description, the collaborative robot 100 is described as a device for performing palletizing or depalletizing, but is not limited thereto, and various collaborative robots capable of performing cooperation with a worker in an industrial field may be applied.

Specifically, the collaborative robot 100 may be a device capable of gripping an article and loading the article on a pallet or discharging an article loaded on the pallet. For example, the collaborative robot 100 may include a robot arm and a gripping unit.

The robot arm may include a plurality of links, at least one joint connecting the plurality of links, and a gripper bracket coupled to an end of a terminal link among the plurality of links. The gripping unit may be installed at an end of the robot arm to grip an article or release gripping of a gripped article to place down the article. According to an embodiment of the present disclosure, a vacuum gripper capable of gripping an article in a standardized box shape may be applied as the gripping unit. However, the present disclosure is not limited thereto, and various types of grippers such as a finger gripper, a soft gripper, and a gecko gripper may be applied as the gripping unit.

As another component, the camera 200 may be installed throughout an industrial field to acquire a video of the collaborative robot 100 or a worker. In addition, the camera 200 may acquire a video of the industrial field and transmit the video to the management server 300 in real time. Here, the camera 200 may be a CCTV (Closed-Circuit Television) used for security, surveillance, and the like in the industrial field.

The video acquired from the camera 200 may be used for analyzing a shape of an article to be processed by the collaborative robot 100, a movement of the collaborative robot 100, a movement of a worker, and the like. In addition, the video acquired from the camera 200 may be used for monitoring whether safety equipment is worn, a state of the worker, and the like by analyzing a shape of the worker.

For example, the camera 200 may include at least one combination of a vision camera and a thermal camera.

As another component, the management server 300 may integrally control movement of the collaborative robot 100 used in the industrial field. In addition, the management server 300 may monitor states of workers who work in cooperation with the collaborative robot 100 in the industrial field. Such a management server 300 may also be referred to as an RCS (Remote Control System).

Specifically, the management server 300 may generate a virtual safety fence based on a work path of the collaborative robot 100 in a video of an industrial field in which the collaborative robot 100 is located, and may detect whether a worker enters the virtual safety fence generated based on the video.

In addition, the management server 300 may set a work plan of the collaborative robot 100, estimate a work path of the collaborative robot 100 according to the set work plan, and set a virtual safety fence based on the estimated work path of the collaborative robot 100.

Further, the management server 300 may output a video of an industrial field in which the collaborative robot 100 is located, display a virtual safety fence set based on a work radius of the collaborative robot 100 in the output video, receive a manipulation signal for manipulating the virtual safety fence, and variably set the virtual safety fence according to the manipulation signal.

The management server 300 is not limited to the term “server,” and any device may be allowed as long as the device can transmit and receive data to and from the collaborative robot 100 and the camera 200 and perform operations based on the transmitted and received data.

For example, the management server 300 may be any one of fixed computing devices such as a desktop and a workstation, but is not limited thereto.

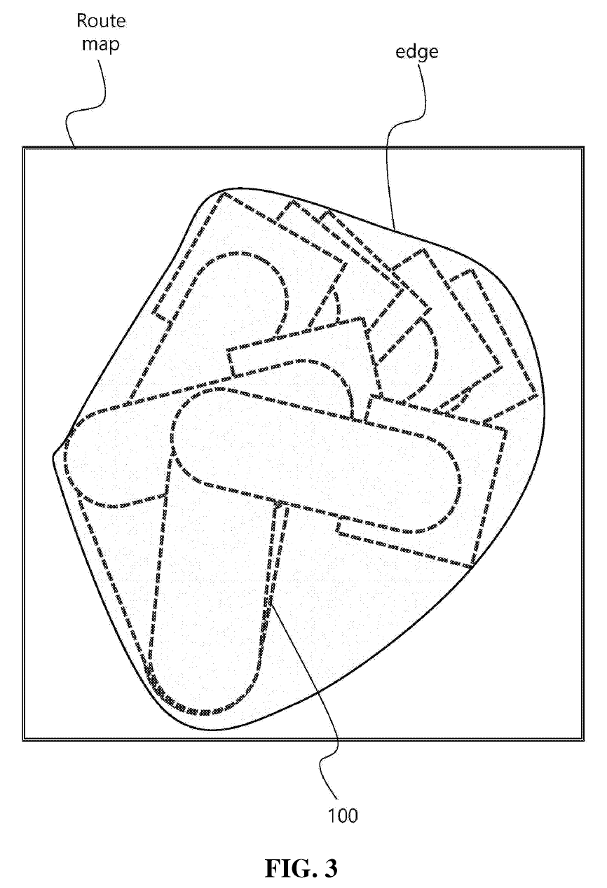

Detailed configurations and operations of the management server 300 according to an embodiment of the present disclosure will be described later with reference to FIGS. 3 to 8.

As described above, the collaborative robot 100, the camera 200, and the management server 300 may transmit and receive data using a network including one or more of a security line directly connecting devices, a public wired communication network, and a mobile communication network.

For example, the public wired communication network may include Ethernet, x Digital Subscriber Line (xDSL), Hybrid Fiber Coax (HFC), and Fiber To The Home (FTTH), but is not limited thereto. In addition, the mobile communication network may include Code Division Multiple Access (CDMA), Wideband CDMA (WCDMA), High Speed Packet Access (HSPA), Long Term Evolution (LTE), and 5th/6th generation mobile telecommunication, but is not limited thereto.

Hereinafter, a configuration of the management server 300 according to an embodiment of the present disclosure will be described in more detail.

FIG. 2 is a logical configuration diagram of a management server according to an embodiment of the present disclosure.

As illustrated in FIG. 2, the management server 300 according to an embodiment of the present disclosure may include a communication unit 305, an input/output unit 310, a boundary generation unit 315, a detection unit 320, a robot control unit 325, and a management unit 330.

Components of the management server 300 according to an embodiment of the present disclosure merely represent functionally distinguished components, and thus two or more components may be implemented in an integrated manner in an actual physical environment, or one component may be implemented in a separated manner in an actual physical environment.

Specifically, the communication unit 305 may receive state information from the collaborative robot 100. In addition, the communication unit 305 may transmit a control command to the collaborative robot 100. Further, the communication unit 305 may receive a captured video from the camera 200.

In addition, the communication unit 305 may transmit and receive data to and from an MES (Manufacturing Execution System), an MCS (Material Control System), a WMS (Warehouse Management Cloud), and the like through EIF (Equipment InterFace).

As another component, the input/output unit 310 may receive information or a command from a user through a user interface (User Interface, UI), and may output an operation result to the outside. Specifically, the input/output unit 310 may receive a command for control of the collaborative robot 100. Further, the input/output unit 310 may output state information of the collaborative robot 100.

As another component, the boundary generation unit 315 may set a virtual safety fence capable of securing safety according to a work plan of the collaborative robot 100.

To this end, the boundary generation unit 315 may set a work plan of the collaborative robot 100.

Specifically, the boundary generation unit 315 may set the work plan based on at least one of operation speed information, kinematics information, and obstacle information of the collaborative robot 100.

Here, the operation speed information may include information on a moving distance and acceleration that each joint or an end-effector of the collaborative robot 100 can perform per unit time, and may be used as basic data for predicting an expected movement pattern, a possibility of collision, a work time, and the like on a work path. By analyzing the operation speed information, the boundary generation unit 315 may coordinate an optimal movement path and timing between works within a predetermined work.

The kinematics information refers to kinematic characteristics of the collaborative robot 100, and may include information such as a link length and a joint limit angle, and may be used to determine whether the collaborative robot 100 can reach a specific point and whether the collaborative robot 100 can naturally move along a specific path. The boundary generation unit 315 may plan a path and an operation sequence by which the collaborative robot 100 can perform a work safely while satisfying mechanical constraint conditions of the collaborative robot 100 through the kinematics information.

The obstacle information may include a position, size, movement pattern, and the like of a fixed or moving obstacle present in a work environment in which the collaborative robot 100 operates, may be collected through an environment database constructed in advance, and may be used as an essential factor for preventing a risk of collision in advance when setting a work path and a speed of the collaborative robot 100.

As described above, the boundary generation unit 315 may set an optimal work plan by considering, in a converged manner, at least one of the operation speed information, the kinematics information, and the obstacle information, so that the collaborative robot 100 can safely and efficiently perform a given work.

In addition, the boundary generation unit 315 may provide an interface through which an administrator can simulate a work plan in a virtual environment.

Specifically, the boundary generation unit 315 may generate a virtual collaborative robot kinematically corresponding to the collaborative robot 100, and may visually express the virtual collaborative robot on a GUI (Graphical User Interface) operable by a user through the input/output unit 310. Here, the boundary generation unit 315 may generate the virtual collaborative robot by reflecting a joint configuration, a link length, a work radius, and the like of the actual collaborative robot 100. Further, the administrator may manipulate an operation of the virtual collaborative robot through the GUI (Graphical User Interface) by using drag-and-drop, a mouse gesture, coordinate input, and the like.

For example, the administrator may directly input the work plan by moving the virtual collaborative robot to a desired work position through the GUI (Graphical User Interface) or by designating an operation sequence step by step.

In addition, the boundary generation unit 315 may visually display a position of an obstacle in the virtual environment or provide a function of warning a collision risk section in real time. Through this, the administrator may easily design a path by which the collaborative robot 100 can avoid an obstacle in performing a specific work, and may visually review safety and efficiency of the work path.

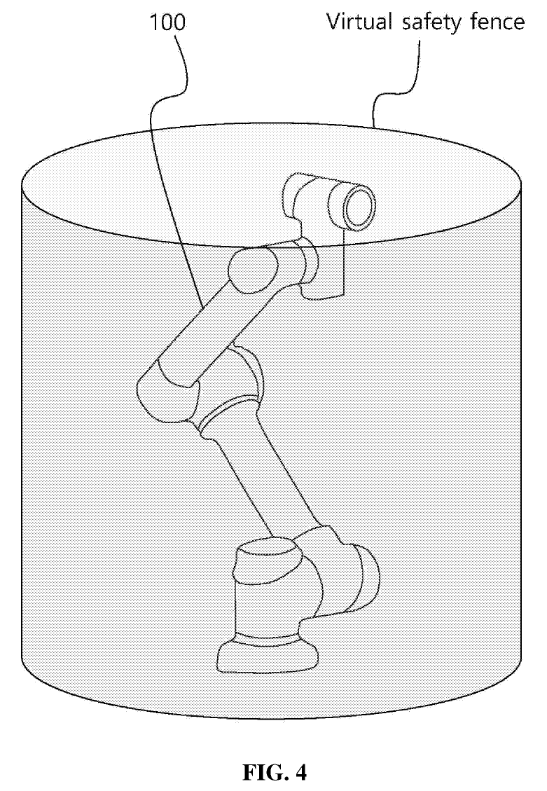

Referring briefly to FIGS. 3 and 4, a process of setting a virtual safety fence according to an embodiment of the present disclosure will be described in detail.

FIG. 3 is an exemplary diagram illustrating a Route map according to an embodiment of the present disclosure, and FIG. 4 is an exemplary diagram illustrating a virtual safety fence according to an embodiment of the present disclosure.

Referring to FIG. 3, the boundary generation unit 315 may simulate a movement of the collaborative robot 100 and generate a superimposed Route map.

Specifically, the boundary generation unit 315 may predict a path along which the collaborative robot 100 will actually move in a space by simulating an operation scenario of the collaborative robot 100 based on the set work plan. In this process, the boundary generation unit 315 may dynamically calculate movements of respective joints of the collaborative robot 100, a trajectory of an end-effector, an operation speed, and changes in position according to time, and may simulate an overall movement pattern in a virtual environment during performance of a work.

In order to visually clearly express such a simulation result, the boundary generation unit 315 may set a view point to a top view, i.e., a viewpoint based on a top view, and may project a work path of the collaborative robot 100 onto a two-dimensional plane.

Based on the generated simulation data, the boundary generation unit 315 may generate an accumulated Route map by superimposing a movement path of the collaborative robot 100. For example, the Route map may be expressed more darkly when an area is moved at a high frequency according to a movement frequency of the collaborative robot 100, and may be expressed more lightly when an area is moved at a low frequency, thereby enabling density-based visualization.

Subsequently, the boundary generation unit 315 may spatially partition an actual work area of the collaborative robot 100 based on the generated Route map of the collaborative robot 100, and may set a corresponding area as a virtual safety fence.

As illustrated in FIG. 3, the boundary generation unit 315 may extract an outer boundary line, i.e., an edge, of an area corresponding to the collaborative robot 100 on the Route map, and may set a virtual safety fence based thereon. Here, the edge may refer to a boundary line forming an outermost boundary on a movement path of the collaborative robot 100 accumulated through simulation.

The boundary generation unit 315 may first set, in two dimensions, a virtual safety fence corresponding to an actual movement path of the collaborative robot 100 based on the edge, and then may generate the virtual safety fence by extending the same into a three-dimensional virtual object in a pillar shape. More specifically, the boundary generation unit 315 may set the edge as a bottom surface of a pillar and add a top surface having a predetermined height, thereby forming a virtual safety fence having a three-dimensional structure in which the bottom surface and the top surface are parallel to each other.

As illustrated in FIG. 4, the boundary generation unit 315 may visually display the set pillar-shaped virtual safety fence. Through this, a worker may intuitively recognize a dangerous range or a restricted area of the collaborative robot 100 based on the virtual safety fence.

Alternatively, the boundary generation unit 315 may generate a virtual safety fence by predicting a work radius based on a predefined work plan and physical shape information of the collaborative robot 100.

Specifically, the boundary generation unit 315 may calculate a spatial range that the collaborative robot 100 can actually reach, i.e., a work radius, based on coordinate information of work points to be performed by the collaborative robot 100 according to the set work plan and shape information of the collaborative robot 100. Here, the work radius may be calculated in consideration of a basic position and an operation range of the collaborative robot 100, and a maximum movement distance of the collaborative robot 100, and may be a maximum space accessible by the collaborative robot 100.

Subsequently, the boundary generation unit 315 may set a virtual safety fence at a position spaced apart by a preset distance or more from an edge of the estimated work radius. That is, the boundary generation unit 315 may set a virtual safety fence by providing a safety margin space outward by a predetermined distance from an outer side of a maximum work area of the collaborative robot 100. Through this, the boundary generation unit 315 may structurally prevent a possibility of collision with a worker or another collaborative robot.

In addition, the boundary generation unit 315 may dynamically adjust the generated virtual safety fence according to operation characteristics of the collaborative robot 100 and worker information.

Specifically, the boundary generation unit 315 may variably set a size of the virtual safety fence based on operation speed information of the collaborative robot 100 according to the work plan. For example, when the collaborative robot 100 performs a work of moving at a high speed, the boundary generation unit 315 may set a size of the virtual safety fence to be larger in expectation that an impact amount will be large when a mechanical error occurs or a collision occurs, and may set only a relatively narrow virtual safety fence in low-speed movement, thereby improving space utilization efficiency of a work space.

In addition, the boundary generation unit 315 may variably change a color of the virtual safety fence according to a speed of the collaborative robot 100, thereby providing a visual warning signal to the administrator. For example, the boundary generation unit 315 may cause the boundary to be displayed in green or blue when the collaborative robot 100 is in a low-speed state, in yellow when the collaborative robot 100 is in a medium-speed state, and in red when the collaborative robot 100 is in a high-speed state, so that the administrator can immediately recognize a current operation state and a risk level of the collaborative robot 100.

Furthermore, the boundary generation unit 315 may receive proficiency information of a worker who is to work together with the collaborative robot 100 according to the work plan, and may automatically adjust a size of the virtual safety fence according to the proficiency. For example, in a case of a beginner worker, the boundary generation unit 315 may set a size of the virtual safety fence to be larger because a reaction speed or attentiveness may be relatively low, and in a case of an advanced worker, may set a narrow virtual safety fence so that a work space can be utilized more efficiently.

As another component, the detection unit 320 may generate a virtual safety fence based on a work path in an industrial field in which the collaborative robot 100 is operated, and may precisely detect whether a worker approaches by monitoring the same based on a real-time video.

To this end, the detection unit 320 may generate a virtual safety fence based on a work path of the collaborative robot 100 in a video of an industrial field in which the collaborative robot 100 is located.

Specifically, the detection unit 320 may analyze a real-time video received from the camera 200 installed in the industrial field, and may simultaneously track a position and a work path of the collaborative robot 100 as well as a position and a movement of a worker. For example, the detection unit 320 may track a change in the worker's position between a plurality of frames included in the video using an object tracking algorithm, and may estimate a movement speed of the worker based on an amount of change in the position per unit time.

The detection unit 320 may variably adjust a size of the virtual safety fence based on a movement speed of the worker. For example, when the worker moves slowly or is in a stopped state, the detection unit 320 may reduce a size of the generated virtual safety fence by a preset size, whereas when the worker moves rapidly or approaches in a direction toward the collaborative robot, the detection unit 320 may determine that a possibility of collision is high and may increase a size of the virtual safety fence by a preset size.

In addition, the detection unit 320 may detect a position and a movement of a worker through not only a visible-light video but also a thermal video, and may generate a virtual safety fence based thereon.

Subsequently, the detection unit 320 may detect whether the worker enters the virtual safety fence generated based on the video.

Specifically, the detection unit 320 may determine whether a worker is present and track a corresponding position based on a thermal image input from a thermal camera capturing the industrial field. In this case, the detection unit 320 may identify a thermal pattern corresponding to body temperature of the worker by analyzing a temperature distribution in the thermal image. For example, when a thermal signal falling within a temperature range corresponding to a human body temperature moves while maintaining a predetermined shape, the detection unit 320 may recognize the thermal pattern as the worker.

Further, by tracking a positional change of the thermal pattern between frames, the detection unit 320 may track, in real time, a movement path of the worker, and may detect whether the worker enters the virtual safety fence of the collaborative robot 100 by analyzing a movement direction and a movement speed.

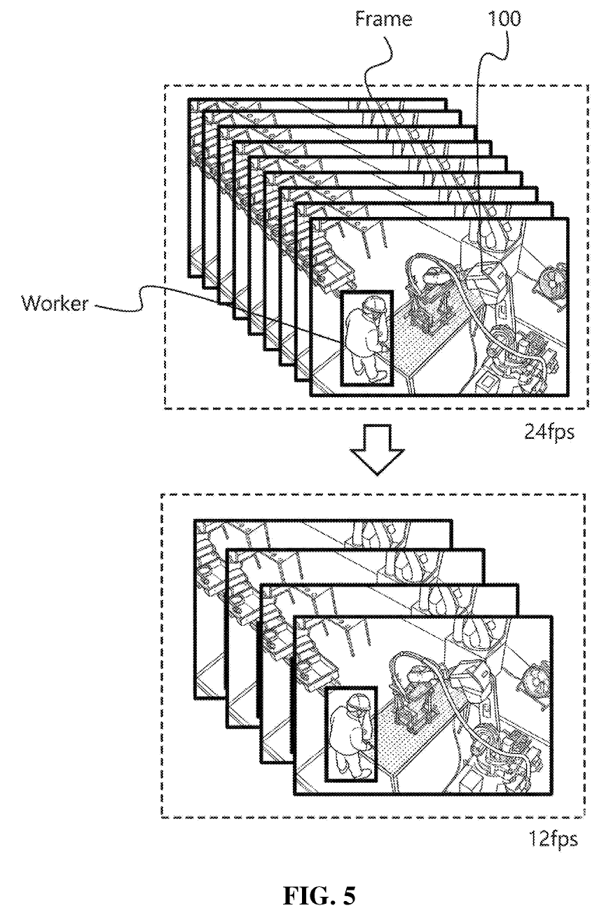

Referring briefly to FIG. 5, the detection unit 320 according to an embodiment of the present disclosure will be described in more detail.

FIG. 5 is an exemplary diagram for explaining a function of a detection unit according to an embodiment of the present disclosure.

Referring to FIG. 5, a process of tracking and detecting a worker according to various embodiments described above is performed by analyzing a video acquired from the camera 200. In this case, the detection unit 320 may reduce an amount of computation by adjusting a frame rate of the video according to a specific situation in video analysis.

According to an embodiment, the detection unit 320 may track a movement of the worker by analyzing a plurality of frames included in the video, and may variably control the frame rate of the video in real time according to the number of workers recognized in the video. For example, when the number of workers is large, the detection unit 320 may increase the frame rate to track detailed movements through more frames, and when the number of workers is small or there is no worker, the detection unit 320 may decrease the frame rate to minimize an amount of computation.

According to another embodiment, the detection unit 320 may track a movement of the worker by analyzing a plurality of frames included in the video, estimate a workload based on the movement of the worker, and variably control the frame rate of the video in real time according to the estimated workload. For example, when the workload is large, the detection unit 320 may increase the frame rate to track detailed movements through more frames, and when the workload is small or there is no workload, the detection unit 320 may decrease the frame rate to minimize an amount of computation.

That is, when a plurality of workers are present in the video or the workload is large, the detection unit 320 may collect more data by increasing the frame rate because it is necessary to observe and track movements of each worker more precisely. Conversely, when the number of workers is small or there is almost no activity, the detection unit 320 may reduce consumption of system resources and power by decreasing the frame rate, and may optimize the system so that unnecessary data is not generated. For example, as illustrated in FIG. 5, in a process of tracking a position of the worker, when the number of workers included in the video decreases from two to one, the detection unit 320 may decrease the frame rate to a preset value.

As described above, since the detection unit 320 adjusts the frame rate in real time whenever the number of workers changes, the detection unit 320 may promptly reflect a change in a situation in a work site and may greatly improve flexibility and resource efficiency of the system.

As another component, the robot control unit 325 may control the collaborative robot 100 according to whether entry of the detected worker is detected.

Specifically, the robot control unit 325 may record a point in time at which the worker enters the virtual safety fence through video analysis, and when the worker does not leave a corresponding area even after a preset time has elapsed after the worker enters the virtual safety fence, the robot control unit 325 may forcibly stop an operation of the collaborative robot 100. In this way, when there is a risk of collision due to long-term stay, the robot control unit 325 may secure worker safety by proactively stopping robot operation.

In addition, the robot control unit 325 may maintain at least one collision detection sensor, installed in the industrial field to detect a collision between the collaborative robot 100 and a worker, in a standby state, and may activate the at least one collision detection sensor when entry of the worker is detected. Through this, the robot control unit 325 may reduce power consumption or an unnecessary malfunction possibility due to constant operation of the collision detection sensor, and at the same time may secure system efficiency and responsiveness by performing substantial detection only when an actual risk exists.

In addition, when entry of the worker is detected, the robot control unit 325 may output an audible warning signal through an output device provided in the industrial field. Further, when entry of the worker is detected, the robot control unit 325 may display a virtual safety fence on a ground through the output device provided in the industrial field. For example, the output device may be a speaker, a projector, a warning light, and the like.

As another component, the management unit 330 may allow an administrator to intuitively check a state of the collaborative robot based on a GUI (Graphical User Interface).

To this end, the management unit 330 may output a video of an industrial field in which the collaborative robot 100 is located. That is, the management unit 330 may visually provide, to the administrator, a position of the collaborative robot 100, a work situation, a surrounding environment, and the like. In this case, the management unit 330 may output, together with the video, a view point selection icon for selecting a viewing point of the output video. For example, the management unit 330 may provide an icon for selecting one of a plurality of view points, such as a top view, a side view, and a perspective view, by which the industrial field may be viewed from various viewpoints.

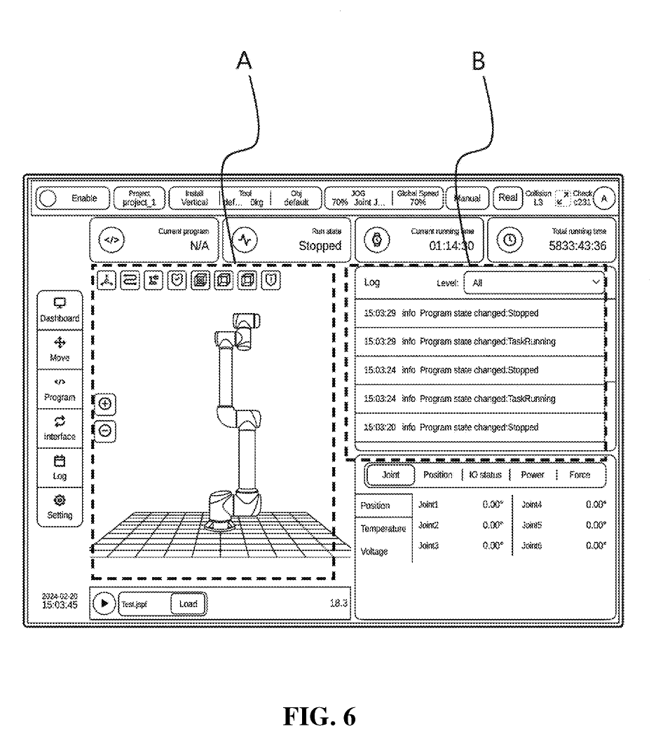

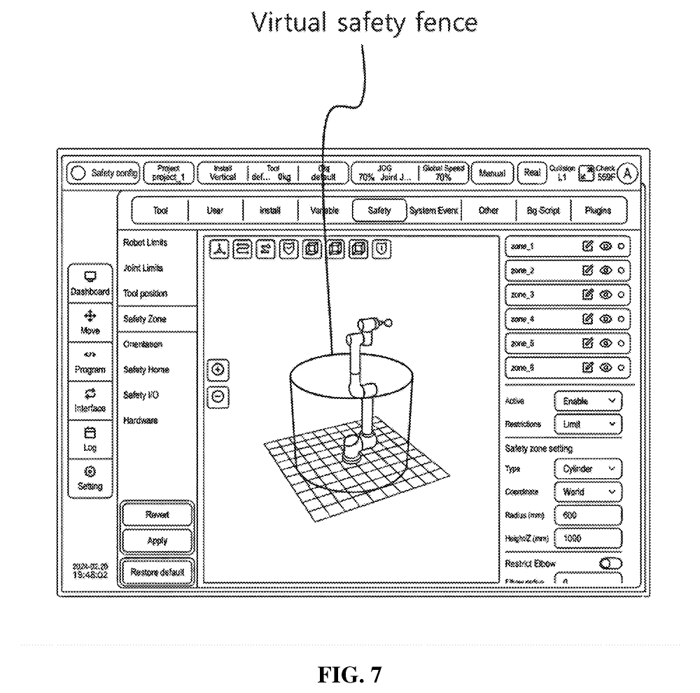

Referring briefly to FIGS. 6 and 7, a function of the management unit 330 according to an embodiment of the present disclosure will be described in more detail.

FIGS. 6 and 7 are exemplary diagrams for explaining a GUI (Graphical User Interface) according to an embodiment of the present disclosure.

As illustrated in FIG. 6, the management unit 330 may output, together with a video A capturing an industrial field, time information and robot state information B in association with each other, so that the administrator can intuitively check and control an operation state of the collaborative robot according to a flow of time.

Specifically, the management unit 330 may assign a timestamp to a real-time video capturing the industrial field or a three-dimensional graphic implemented based on the video, and may output, together with the video, state information of the collaborative robot 100 corresponding to the timestamp. Here, the state information may include a joint angle, a speed, a work mode, an error state, whether a worker is detected, a distance, and the like of the collaborative robot.

For example, the management unit 330 may output the state information in synchronization with playback of the video on the GUI, and may display the state information in a form of a time-based state log on a lower portion of the video or on a right-side information panel, or may output the state information in a popup form when a mouse-over or timeline click is performed.

In addition, the management unit 330 may output a video capturing the industrial field, identify at least one worker in the video through face recognition, and perform de-identification processing on a face of the identified worker.

Specifically, the management unit 330 may estimate whether safety equipment is worn based on a shape of a face of the identified worker, and may convert the face of the worker recognized in the video into a preset image according to the estimated wearing state of the safety equipment. For example, the management unit 330 may output a face of the worker as replaced with a safety helmet image. That is, the management unit 330 may output a blue safety helmet image for a worker wearing a safety helmet, and may output a red safety helmet image for a worker not wearing a safety helmet.

In addition, the management unit 330 may estimate a fatigue level of the identified worker based on a change amount of at least one of a pattern, a frequency, and a speed of movement of the identified worker, and may output a converted image with a different color based on the estimated fatigue level.

Specifically, the management unit 330 may estimate a fatigue level of the worker by analyzing a form of a specific work motion and a repeated pattern through skeleton data of the worker. For example, the management unit 330 may estimate the fatigue level of the worker based on the number of occurrences of a pattern in which a movement of the worker is unnatural or efficiency is lowered. In addition, the management unit 330 may estimate the fatigue level based on a change in a movement speed of the worker.

In addition, the management unit 330 may identify a torso of the worker based on a face of the identified worker, extract an edge of the identified torso, and deform a shape of the extracted edge based on a stored body shape. Specifically, the management unit 330 may identify a torso region by applying an assumption that a body part located below a face is a torso based on a face position. However, the present disclosure is not limited thereto, and the management unit 330 may identify a position of the torso based on skeleton data. Subsequently, the management unit 330 may extract an edge of the identified torso region by applying an edge detection algorithm. Further, the management unit 330 may compare the extracted torso edge of the worker with an edge shape corresponding to a reference body shape stored in a database, and may apply shape deformation to a portion where a difference occurs.

As described above, the management unit 330 may protect privacy of the worker through de-identification of the worker in the video, and at the same time may support the administrator in intuitively identifying a state of the worker by identifying whether safety equipment is worn, a fatigue level, and the like of the worker.

Subsequently, the management unit 330 may display, in the output video, a virtual safety fence set based on a work radius of the collaborative robot 100. In this case, as illustrated in FIG. 7, the management unit 330 may display the virtual safety fence in the output video through a translucent graphic.

Further, the management unit 330 may receive a manipulation signal for manipulating the virtual safety fence, and may variably set the virtual safety fence according to the manipulation signal.

Specifically, the management unit 330 may variably change a size of the virtual safety fence while maintaining a shape of the virtual safety fence through a drag operation of the user. For example, when the virtual safety fence is set in a rectangular shape, when the administrator drags a boundary outward, the management unit 330 may enlarge an entire area while maintaining a shape of the rectangle, and when the administrator drags the boundary inward, the management unit 330 may reduce the area. Alternatively, when the virtual safety fence is set in a circular shape or a polygonal shape, the management unit 330 may proportionally change a radius or a parameter corresponding to a side length according to the drag operation while maintaining a structural ratio of the circle or the polygon.

In this case, the management unit 330 may control an operable range in consideration of an authority level of the administrator manipulating the virtual safety fence, thereby protecting safety and consistency of the system from an abnormal or excessive boundary change.

Specifically, the management unit 330 may identify authority information of the administrator who sets or manipulates the virtual safety fence. Here, the authority information may be acquired from a user authentication point in time or from account information stored in the system. Further, when the administrator attempts to change a size of the virtual safety fence through a drag operation or another input manipulation, the management unit 330 may refer to an allowable minimum range and maximum range based on an authority level of the corresponding administrator, so that a manipulation exceeding the range is restricted from being made.

For example, in a case of a general administrator, the management unit 330 may restrict expansion or reduction of the virtual safety fence to only within a range of ±10%. In addition, in a case of a safety administrator, the management unit 330 may allow adjustment up to ±30% and may output an additional warning in a specific dangerous section. Further, in a case of a system administrator, the management unit 330 may allow manipulation of the entire virtual safety fence without restriction.

Furthermore, the management unit 330 may restrict a variable size of the virtual safety fence according to the identified authority level. That is, the management unit 330 may differently set authority capable of manipulation according to a risk level for each area of the virtual safety fence set in advance.

In addition, the management unit 330 may identify a worker by analyzing a plurality of frames included in the video, and may automatically variably set a size of the virtual safety fence according to the number of identified workers.

According to an embodiment, the management unit 330 may track a movement of the worker by analyzing a plurality of frames included in the video, and may variably control the frame rate of the video in real time according to the number of workers recognized in the video. For example, when the number of workers is large, the management unit 330 may increase the frame rate to track detailed movements through more frames, and when the number of workers is small or there is no worker, the management unit 330 may decrease the frame rate to minimize an amount of computation.

According to another embodiment, the management unit 330 may track a movement of the worker by analyzing a plurality of frames included in the video, estimate a workload based on the movement of the worker, and variably control the frame rate of the video in real time according to the estimated workload. For example, when the workload is large, the management unit 330 may increase the frame rate to track detailed movements through more frames, and when the workload is small or there is no workload, the management unit 330 may decrease the frame rate to minimize an amount of computation.

That is, when a plurality of workers are present in the video or the workload is large, the management unit 330 may collect more data by increasing the frame rate because it is necessary to observe and track movements of each worker more precisely. Conversely, when the number of workers is small or there is almost no activity, the management unit 330 may reduce consumption of system resources and power by decreasing the frame rate, and may optimize the system so that unnecessary data is not generated.

As described above, since the management unit 330 adjusts the frame rate in real time whenever the number of workers changes, the management unit 330 may promptly reflect a change in a situation in a work site and may greatly improve flexibility and resource efficiency of the system.

Hereinafter, hardware for implementing the logical components of the management server 300 described above will be described in more detail.

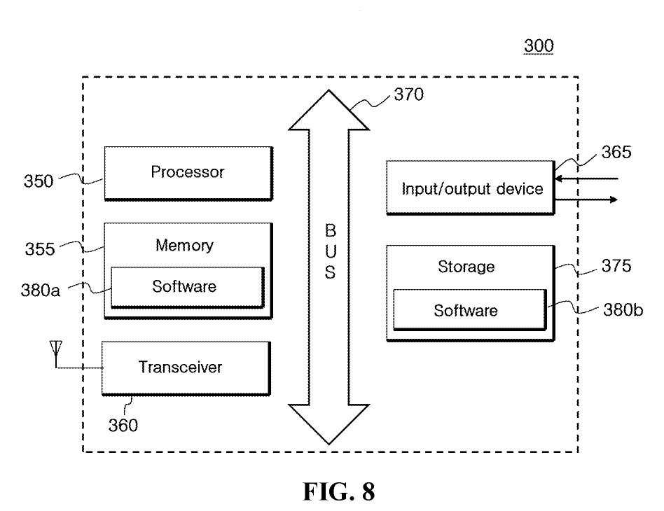

FIG. 8 is a hardware configuration diagram of a management server according to an embodiment of the present disclosure.

As illustrated in FIG. 8, the management server 300 may include a processor 350, a memory 355, a transceiver 360, an input/output device 365, a bus 370, and a storage 375.

Specifically, the processor 350 may implement operations and functions of the management server 300 based on instructions according to software 380a in which a virtual boundary-based collision prevention and work control method using safety signal linkage of a collaborative robot, a user interface-based method for setting a virtual boundary of a work area of a collaborative robot, and an intuitive control method of a collaborative robot using a user-centered graphic interface are implemented, the software 380a being resident in the memory 355.

Software 380b in which a virtual boundary-based collision prevention and work control method using safety signal linkage of a collaborative robot, a user interface-based method for setting a virtual boundary of a work area of a collaborative robot, and an intuitive control method of a collaborative robot using a user-centered graphic interface are implemented, the software 380b being stored in the storage 375, may be loaded in the memory 355.

The input/output device 365 may receive a signal required for an operation of the management server 300 or may output an operation result to the outside according to a command of the processor 350.

The bus 370 may be connected to the processor 350, the memory 355, the transceiver 360, the input/output device 365, and the storage 375, respectively, and may serve as a movement path for transmitting a signal between the respective components.

The storage 375 may store an Application Programming Interface (API), a library file, a resource file, and the like required for execution of the software 380a in which the virtual boundary-based collision prevention and work control method using safety signal linkage of a collaborative robot, the user interface-based method for setting a virtual boundary of a work area of a collaborative robot, and the intuitive control method of a collaborative robot using a user-centered graphic interface according to embodiments of the present disclosure are implemented. The storage 375 may store the software 380b in which the virtual boundary-based collision prevention and work control method using safety signal linkage of a collaborative robot, the user interface-based method for setting a virtual boundary of a work area of a collaborative robot, and the intuitive control method of a collaborative robot using a user-centered graphic interface according to embodiments of the present disclosure are implemented.

According to an embodiment of the present disclosure, the software 380a and 380b for implementing the virtual boundary-based collision prevention and work control method using safety signal linkage of a collaborative robot, the software 380a and 380b being resident in the memory 355 or stored in the storage 375, may be a computer program recorded on record-medium for causing the processor 350 to execute generating a virtual safety fence based on a work path of the collaborative robot in a video capturing an industrial field in which the collaborative robot is located, and detecting whether a worker enters the virtual safety fence generated based on the video.

According to another embodiment of the present disclosure, the software 380a and 380b for implementing the user interface-based method for setting a virtual boundary of a work area of a collaborative robot, the software 380a and 380b being resident in the memory 355 or stored in the storage 375, may be a computer program recorded on record-medium for causing the processor 350 to execute setting a work plan of the collaborative robot, estimating a work path of the collaborative robot according to the set work plan, and setting a virtual safety fence based on the estimated work path of the collaborative robot.

According to still another embodiment of the present disclosure, the software 380a and 380b for implementing the user interface-based method for setting a virtual boundary of a work area of a collaborative robot, the software 380a and 380b being resident in the memory 355 or stored in the storage 375, may be a computer program recorded on record-medium for causing the processor 350 to execute outputting a video capturing an industrial field in which the collaborative robot is located, displaying a virtual safety fence set based on a work radius of the collaborative robot in the output video, receiving a manipulation signal for manipulating the virtual safety fence, and variably setting the virtual safety fence according to the manipulation signal.

More specifically, the processor 350 may include one or more of a Central Processing Unit (CPU), an Application-Specific Integrated Circuit (ASIC), a chipset, and a logic circuit, but is not limited thereto.

The memory 355 may include one or more of a ROM (Read-Only Memory), a RAM (Random Access Memory), a flash memory, and a memory card, but is not limited thereto.

The input/output device 365 may include one or more of an input device such as a button, a switch, a keyboard, a mouse, and a joystick, and an output device such as an LCD (Liquid Crystal Display), an LED (Light Emitting Diode), an Organic LED (OLED), an Active Matrix OLED (AMOLED), a printer, and a plotter, but is not limited thereto.

When an embodiment included in the present specification is implemented as software, the above-described method may be implemented as modules (processes, functions, and the like) respectively performing the above-described functions. Each module may be resident in the memory 355 and may be executed by the processor 350. The memory 355 may exist inside or outside the processor 350, and may be connected to the processor 350 by various well-known means.

Each component illustrated in FIG. 8 may be implemented by various means (for example, hardware, firmware, software, or a combination thereof). When implemented by hardware, an embodiment of the present disclosure may be implemented by one or more ASICs (Application Specific Integrated Circuits), DSPs (Digital Signal Processors), DSPDs (Digital Signal Processing Devices), PLDs (Programmable Logic Devices), FPGAs (Field Programmable Gate Arrays), processors, controllers, microcontrollers, microprocessors, and the like.

In addition, when implemented by firmware or software, an embodiment of the present disclosure may be implemented in a form of modules, procedures, functions, and the like performing the functions or operations described above, and may be recorded on a record-medium readable through various computer means. Here, the record-medium may include program instructions, data files, data structures, and the like alone or in combination.

Program instructions recorded on the record-medium may be those specially designed and configured for the present disclosure, or may be those known and available to those skilled in the art of computer software. For example, the record-medium includes magnetic media such as a hard disk, a floppy disk, and a magnetic tape, optical recording media such as a CD-ROM (Compact Disk Read Only Memory) and a DVD (Digital Video Disk), magneto-optical media such as a Floptical Disk, and hardware devices specially configured to store and execute program instructions, such as a ROM, a RAM, and a flash memory.

Examples of the program instructions may include not only machine language codes such as those generated by a compiler, but also high-level language codes executable by a computer through the use of an interpreter or the like. Such a hardware device may be configured to operate as one or more software items in order to perform an operation of the present disclosure, and vice versa.

Hereinafter, a user interface-based method for setting a virtual boundary of a work area of a collaborative robot according to an embodiment of the present disclosure will be described.

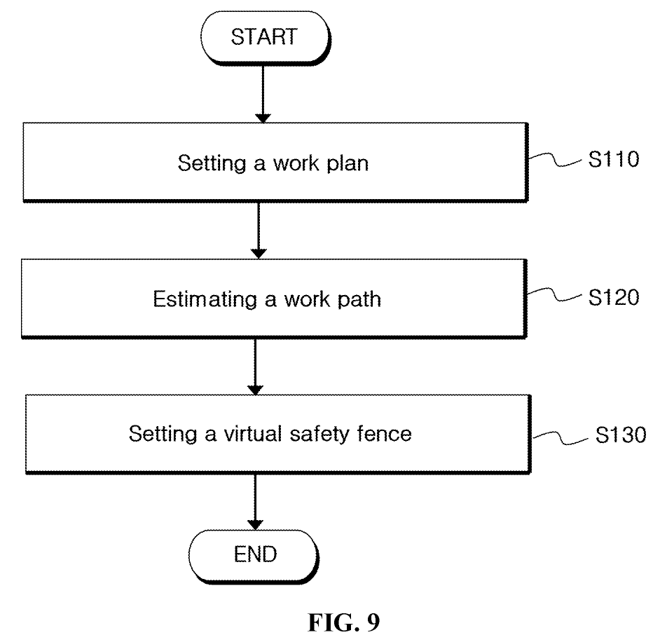

FIG. 9 is a flowchart for explaining a user interface-based method for setting a virtual boundary of a work area of a collaborative robot according to an embodiment of the present disclosure.

Referring to FIG. 9, in operation S110, the management server may set a work plan of the collaborative robot.

Specifically, the management server may set the work plan based on at least one of operation speed information, kinematics information, and obstacle information of the collaborative robot.

Alternatively, the management server may provide, to an administrator, an interface through which the work plan can be simulated in a virtual environment.

Specifically, the management server may generate a virtual collaborative robot kinematically corresponding to the collaborative robot, and may visually express the virtual collaborative robot on a GUI (Graphical User Interface) operable by a user. Here, the management server may generate the virtual collaborative robot by reflecting a joint configuration, a link length, a work radius, and the like of the actual collaborative robot. Further, the administrator may manipulate an operation of the virtual collaborative robot through the GUI (Graphical User Interface) by using drag-and-drop, a mouse gesture, coordinate input, and the like.

In addition, the management server may visually display a position of an obstacle in the virtual environment or provide a function of warning a collision risk section in real time. Through this, the administrator may easily design a path by which the collaborative robot can avoid an obstacle in performing a specific work, and may visually review safety and efficiency of the work path.

Next, in operation S120, the management server may estimate a work path of the collaborative robot according to the set work plan.

Specifically, the management server may simulate a movement of the collaborative robot and may generate a superimposed Route map.

That is, the management server may predict a path along which the collaborative robot will actually move in a space by simulating an operation scenario of the collaborative robot based on the set work plan. In this process, the management server may dynamically calculate movements of respective joints of the collaborative robot, a trajectory of an end-effector, an operation speed, and changes in position according to time, and may simulate an overall movement pattern in a virtual environment during performance of a work.

In order to visually clearly express such a simulation result, the management server may set a view point to a top view, i.e., a viewpoint based on a top view, and may project a work path of the collaborative robot onto a two-dimensional plane.

Based on the generated simulation data, the management server may generate an accumulated Route map by superimposing a movement path of the collaborative robot.

In operation S130, the management server may spatially partition an actual work area of the collaborative robot based on the generated Route map of the collaborative robot, and may set a corresponding area as a virtual safety fence.

In this case, the management server may extract an outer boundary line, i.e., an edge, of an area corresponding to the collaborative robot on the Route map, and may set a virtual safety fence based thereon. Here, the edge may refer to a boundary line forming an outermost boundary on a movement path of the collaborative robot accumulated through simulation.

The management server may first set, in two dimensions, a virtual safety fence corresponding to an actual movement path of the collaborative robot based on the edge, and then may generate the virtual safety fence by extending the same into a three-dimensional virtual object in a pillar shape. More specifically, the management server may set the edge as a bottom surface of a pillar and add a top surface having a predetermined height, thereby forming a virtual safety fence having a three-dimensional structure in which the bottom surface and the top surface are parallel to each other.

Alternatively, the management server may generate a virtual safety fence by predicting a work radius based on a predefined work plan and physical shape information of the collaborative robot 100.

Specifically, the management server may calculate a spatial range that the collaborative robot can actually reach, i.e., a work radius, based on coordinate information of work points to be performed by the collaborative robot according to the set work plan and shape information of the collaborative robot. Here, the work radius may be calculated in consideration of a basic position and an operation range of the collaborative robot, and a maximum movement distance of the collaborative robot, and may be a maximum space accessible by the collaborative robot.

Subsequently, the management server may set a virtual safety fence at a position spaced apart by a preset distance or more from an edge of the estimated work radius. That is, the management server may set a virtual safety fence by providing a safety margin space outward by a predetermined distance from an outer side of a maximum work area of the collaborative robot. Through this, the management server may structurally prevent a possibility of collision with a worker or another collaborative robot.

In addition, the management server may dynamically adjust the generated virtual safety fence according to operation characteristics of the collaborative robot and worker information. Specifically, the management server may variably set a size of the virtual safety fence based on operation speed information of the collaborative robot according to the work plan.

In addition, the management server may variably change a color of the virtual safety fence according to a speed of the collaborative robot, thereby providing a visual warning signal to the administrator.

Furthermore, the management server may receive proficiency information of a worker who is to work together with the collaborative robot according to the work plan, and may automatically adjust a size of the virtual safety fence according to the proficiency.

Hereinafter, a virtual boundary-based collision prevention and work control method using safety signal linkage of a collaborative robot according to an embodiment of the present disclosure will be described in detail.

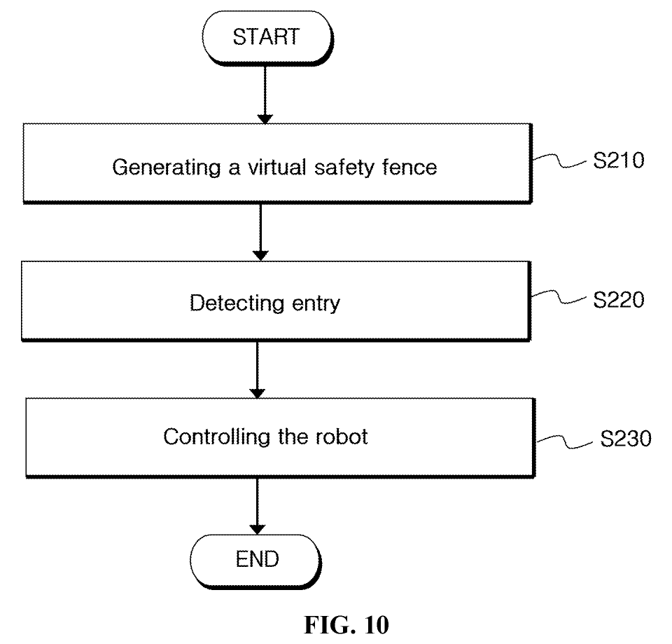

FIG. 10 is a flowchart for explaining a virtual boundary-based collision prevention and work control method using safety signal linkage of a collaborative robot according to an embodiment of the present disclosure.

Referring to FIG. 10, in operation S210, the management server may generate a virtual safety fence based on a work path of the collaborative robot in a video capturing an industrial field in which the collaborative robot is located.

Meanwhile, since the operation of generating the virtual safety fence according to operation S210 may be generated through the above-described user interface-based method for setting a virtual boundary of a work area of a collaborative robot, overlapping descriptions thereof will be omitted.

Next, in operation S220, the management server may precisely detect whether a worker approaches by generating a virtual safety fence based on a work path in an industrial field in which the collaborative robot is operated and monitoring the same based on a real-time video.

To this end, the management server may generate a virtual safety fence based on a work path of the collaborative robot in a video capturing an industrial field in which the collaborative robot is located.

Specifically, the management server may analyze a real-time video received from a camera installed in the industrial field, and may simultaneously track a position and a work path of the collaborative robot as well as a position and a movement of a worker.

The management server may variably adjust a size of the virtual safety fence based on a movement speed of the worker. In addition, the management server may detect a position and a movement of the worker through not only a visible-light video but also a thermal video, and may generate a virtual safety fence based thereon.

Subsequently, the management server may detect whether the worker enters the virtual safety fence generated based on the video.

Specifically, the management server may determine whether a worker is present and track a corresponding position based on a thermal image input from a thermal camera capturing the industrial field. In this case, the management server may identify a thermal pattern corresponding to body temperature of the worker by analyzing a temperature distribution in the thermal image.

Further, by tracking a positional change of the thermal pattern between frames, the management server may track, in real time, a movement path of the worker, and may detect whether the worker enters the virtual safety fence of the collaborative robot by analyzing a movement direction and a movement speed.

In this case, the management server may reduce an amount of computation by adjusting a frame rate of the video according to a specific situation in video analysis.

According to an embodiment, the management server may track a movement of the worker by analyzing a plurality of frames included in the video, and may variably control the frame rate of the video in real time according to the number of workers recognized in the video.

According to another embodiment, the management server may track a movement of the worker by analyzing a plurality of frames included in the video, estimate a workload based on the movement of the worker, and variably control the frame rate of the video in real time according to the estimated workload.

As described above, since the management server adjusts the frame rate in real time whenever the number of workers changes, the management server may promptly reflect a change in a situation in a work site and may greatly improve flexibility and resource efficiency of the system.

In operation S230, the management server may control the collaborative robot according to whether entry of the detected worker is detected.

Specifically, the management server may record a point in time at which the worker enters the virtual safety fence through video analysis, and when the worker does not leave a corresponding area even after a preset time has elapsed after the worker enters the virtual safety fence, the management server may forcibly stop an operation of the collaborative robot.

In addition, the management server may maintain at least one collision detection sensor, installed in the industrial field to detect a collision between the collaborative robot and the worker, in a standby state, and may activate the at least one collision detection sensor when entry of the worker is detected.

The management server may output an audible warning signal through an output device provided in the industrial field when entry of the worker is detected. Further, when entry of the worker is detected, the management server may display a virtual safety fence on a ground through the output device provided in the industrial field.

Hereinafter, an intuitive control method of a collaborative robot using a user-centered graphic interface according to an embodiment of the present disclosure will be described.

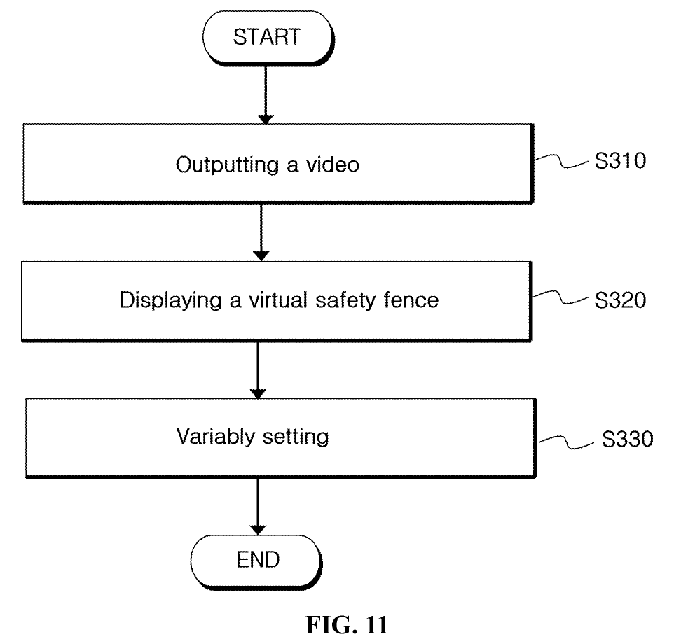

FIG. 11 is a flowchart for explaining an intuitive control method of a collaborative robot using a user-centered graphic interface according to an embodiment of the present disclosure.

Referring to FIG. 11, in operation S310, the management server may output a video capturing an industrial field in which the collaborative robot is located. That is, the management server may visually provide, to the administrator, a position of the collaborative robot, a work situation, a surrounding environment, and the like. In this case, the management server may output, together with the video, a view point selection icon for selecting a viewing point of the output video.

In addition, the management server may output, together with a video capturing the industrial field, time information and robot state information in association with each other, so that the administrator can intuitively check and control an operation state of the collaborative robot according to a flow of time.

Specifically, the management server may assign a timestamp to a real-time video capturing the industrial field or a three-dimensional graphic implemented based on the video, and may output, together with the video, state information of the collaborative robot corresponding to the timestamp. Here, the state information may include a joint angle, a speed, a work mode, an error state, whether a worker is detected, a distance, and the like of the collaborative robot.

In addition, the management server may output a video capturing the industrial field, identify at least one worker in the video through face recognition, and perform de-identification processing on a face of the identified worker.

Specifically, the management server may estimate whether safety equipment is worn based on a shape of a face of the identified worker, and may convert a face of the worker recognized in the video into a preset image according to the estimated wearing state of the safety equipment.

Next, in operation S320, the management server may display, in the output video, a virtual safety fence set based on a work radius of the collaborative robot. In this case, the management server may display the virtual safety fence in the output video through a translucent graphic.

Further, in operation S330, the management server may receive a manipulation signal for manipulating the virtual safety fence, and may variably set the virtual safety fence according to the manipulation signal.

Specifically, the management server may variably change a size of the virtual safety fence while maintaining a shape of the virtual safety fence through a drag operation of the user.

In this case, the management server may control an operable range in consideration of an authority level of the administrator manipulating the virtual safety fence, thereby protecting safety and consistency of the system from an abnormal or excessive boundary change.

Specifically, the management server may identify authority information of the administrator who sets or manipulates the virtual safety fence. Here, the authority information may be acquired from a user authentication point in time or from account information stored in the system. Further, when the administrator attempts to change a size of the virtual safety fence through a drag operation or another input manipulation, the management server may refer to an allowable minimum range and maximum range based on an authority level of the corresponding administrator, so that a manipulation exceeding the range is restricted from being made.

Furthermore, the management server may restrict a variable size of the virtual safety fence according to the identified authority level. That is, the management server may differently set authority capable of manipulation according to a risk level for each area of the virtual safety fence set in advance.

In addition, the management server may identify a worker by analyzing a plurality of frames included in the video, and may automatically variably set a size of the virtual safety fence according to the number of identified workers.

According to an embodiment, the management server may track a movement of the worker by analyzing a plurality of frames included in the video, and may variably control a frame rate of the video in real time according to the number of workers recognized in the video.

According to another embodiment, the management server may track a movement of the worker by analyzing a plurality of frames included in the video, estimate a workload based on the movement of the worker, and may variably control the frame rate of the video in real time according to the estimated workload.

As described above, since the management server adjusts the frame rate in real time whenever the number of workers changes, the management server may promptly reflect a change in a situation in a work site and may greatly improve flexibility and resource efficiency of the system.

As described above, preferred embodiments of the present disclosure have been disclosed in the specification and the drawings. However, it will be apparent to those skilled in the art to which the present disclosure pertains that other modifications based on the technical spirit of the present disclosure may be practiced in addition to the embodiments disclosed herein. In addition, although specific terms are used in the specification and the drawings, they are merely used in a general sense for the purpose of easily describing the technical contents of the present disclosure and helping understanding of the present disclosure, and are not intended to limit the scope of the present disclosure. Therefore, it should be understood that the above-described detailed description is illustrative in all respects and not restrictive. The scope of the present disclosure should be determined by reasonable interpretation of the appended claims, and all changes within the equivalent scope of the present disclosure are included in the scope of the present disclosure.

### REFERENCE SIGNS LIST

100 collaborative robot

200 camera

300 management server

305 communication unit

310 input/output unit

315 boundary generation unit

320 detection unit

325 robot control unit

330 management unit

What is claimed is:

1. A user interface-based method for setting a virtual boundary of a work area of a collaborative robot, the method comprising:
setting, by a management server, a work plan of a collaborative robot;
estimating, by the management server, a work path of the collaborative robot according to the set work plan; and
setting, by the management server, a virtual safety fence based on the estimated work path of the collaborative robot.

2. The method of claim 1, wherein the setting of the work plan comprises setting the work plan based on at least one of operation speed information, kinematics information, and obstacle information of the collaborative robot.

3. The method of claim 1, wherein the setting of the work plan comprises generating a virtual collaborative robot corresponding to the collaborative robot, and receiving, from an administrator, the work plan through a GUI (Graphical User Interface) for moving the virtual collaborative robot.

4. The method of claim 1, wherein the estimating comprises simulating a movement of the collaborative robot based on the set work plan to generate a Route map in which a movement path of the collaborative robot is superimposed.

5. The method of claim 4, wherein the estimating comprises setting a view point to a top view, and simulating a movement of the collaborative robot to generate the Route map.

6. The method of claim 5, wherein the setting comprises setting a virtual safety fence corresponding to an actual movement path of the collaborative robot based on an edge of an area corresponding to the collaborative robot on the Route map.

7. The method of claim 6, wherein the setting comprises setting a pillar-shaped virtual safety fence having, as a bottom surface and a top surface thereof, the edge of the area corresponding to the collaborative robot on the Route map.

8. The method of claim 1, wherein the setting comprises variably setting a color of the virtual safety fence according to a speed of the collaborative robot according to the work plan.

9. The method of claim 1, wherein the setting comprises receiving proficiency of a worker to work together with the collaborative robot according to the work plan, and variably setting a size of the virtual safety fence according to the received proficiency of the worker.

10. a memory;
a transceiver; and
a computer program recorded on record-medium for executing method therefor, the computer program being coupled with a computing device comprising a processor configured to process instructions resident in the memory,
wherein the processor executes: setting a work plan of a collaborative robot; estimating a work path of the collaborative robot according to the set work plan; and setting a virtual safety fence based on the estimated work path of the collaborative robot.
